(19) United States
(12) Patent Application Publication
(10) Pub. No.: US 2024/0416258 A1
(43) Pub. Date: Dec. 19, 2024

(54) METHOD FOR AN AUTOMATIC LIQUID-LIQUID EXTRACTION

(71) Applicant: Metrohm AG, Herisau (CH)

(72) Inventors: Gerhard SCHÖNENBERGER, Aarau (CH); Volker Jörg FROST, Winterthur (CH)

(73) Assignee: Metrohm AG, Herisau (CH)

(21) Appl. No.: 18/702,357

(22) PCT Filed: Oct. 18, 2022
(86) PCT No.: PCT/EP2022/078896

§ 371 Date: Apr. 18, 2024

(30) Foreign Application Priority Data
Oct. 18, 2021 (EP) 21203256.9

(51) Int. Cl. B01D 11/04

(52) U.S. Cl. CPC B01D 11/0484

(57) ABSTRACT

The invention relates to a method for automated liquid-liquid extraction. The method comprises the steps of:
i) providing an extraction device,
ii) providing a vessel with a hydrophilic phase and a hydrophobic phase, wherein at least one component to be extracted is contained in one of the two phases,
iii) determining a conductivity difference ΔLᵢₛₜ between the hydrophilic phase and the hydrophobic phase using a conductivity sensor.

The upper phase is extracted at at least two different speeds v₁ to vₙ, wherein the last speed vₙ is slower than a previous speed vₙ₋₁, preferably slower than v₁ to vₙ₋₁.

The invention relates to a method for automated liquid-liquid extraction, an extraction device for carrying out such a method and a computer program according to the general concepts of the independent claims.

In an extraction, components are dissolved out of a specific mixture of substances using a selective solvent. In a liquid-liquid extraction, both the mixture of substances and the solvent are present in liquid form and at least one component to be extracted from the mixture of substances is dissolved out of the mixture using a solvent. The solvent should have a similar polarity to the component to be extracted and a sufficient difference in density to the substance mixture or extraction material. As a rule, several extraction steps are necessary to ensure exhaustive extraction. Manual extractions are therefore time-consuming and also very error-prone. Reproducibility is not always guaranteed.

Automated extraction methods are increasingly finding their way into analytical laboratories. The focus here is primarily on the extraction of substances to be analysed, often in small quantities. There are therefore no special requirements for exhaustive extractions.

The situation is more difficult for the extraction of components from syntheses or for large-volume analysis samples, such as in wastewater analysis, which on the one hand must be as quantitative as possible, must be reproducible and require precise work and on the other hand use larger volumes than previously known extraction machines. Furthermore, there is a lack of extraction machines in the prior art that can automatically solve typical problems that can occur during extraction.

The industrial continuous extraction apparatus known in the prior art (e.g. mixer-settler systems), in which the phases are discharged via a weir and not, for example, suctioned off, also have the disadvantages that they require a large footprint and that phase separation takes a long time for phases that are difficult to separate.

It is therefore at least one object of the present invention to overcome the disadvantages of the prior art. In particular, it is an object of the invention to provide an automated liquid-liquid extraction for syntheses and thus also larger volumes. Furthermore, it is an object of the invention to provide an automated extraction process which can automatically solve typical problems of liquid-liquid extraction.

The objects defined in the independent claims solve the objects. Special embodiments can be found in the dependent claims.

A first aspect of the invention relates to a method for automated liquid-liquid extraction. The method comprises the steps of:
i) providing an extraction device,
ii) providing a vessel with a hydrophilic phase and a hydrophobic phase, wherein at least one component to be extracted is contained in one of the two phases,
iii) determining a conductivity difference ΔLᵢₛₜ between the hydrophilic phase and the hydrophobic phase using a conductivity sensor.

The upper phase is extracted at at least two different speeds v₁ to vₙ, wherein the last speed vₙ is slower than a previous speed vₙ₋₁, preferably slower than v₁ to vₙ₋₁.

The main flow direction of the liquids in the method is essentially vertical (unlike in flow-through apparatus, where the main flow direction is essentially horizontal). In particular, the vessel for holding the extraction mixture has only one access point.

Suction in at least two speeds with a final speed slower than the previous speed enables particularly gentle suction in the area of the phase boundary and prevents liquid from being sucked up from the lower phase.

Automatic liquid-liquid extraction is particularly suitable for larger volumes, such as those used in organic syntheses or sample preparation, for example in waste water analysis. Sample volumes of 10 ml to 200 ml can be extracted with 10 ml to approx. 70 ml of extraction solvent each.

The hydrophilic phase can be an inorganic phase, preferably an aqueous phase, and the hydrophobic phase can be an organic phase. Particularly preferably, the organic phase has a lower density than the inorganic phase and forms the upper phase after extraction. The inorganic phase preferably forms the lower phase.

For example, the hydrophilic phase or the hydrophobic phase can originate from a sample volume of an organic synthesis. Preferably, the typical steps of an extraction are carried out between steps i) and ii). For example, the sample volume can first be introduced as a first phase, an extraction agent in the form of a phase of opposite polarity can be added, mixing by shaking or stirring, wherein stirring is preferred, of the phases can be carried out and then a resting time for phase separation can be allowed.

It is also possible to determine a theoretical height of the phase boundary. For example, this can be done using the sample volume from the synthesis or a starting volume provided or a conductivity scan carried out beforehand, which can be switched on and off using software. The extraction agent, optionally a diluent and optionally an extraction aid can then be added and the contents of the vessel mixed by stirring and a separation time waited for. The stirring time, or alternatively a shaking time, can be set using software or a computer program. Software and computer program are synonymous in the sense of the present invention.

Advantageously, the conductivity sensor is guided through the phases in such a way that the determined conductivities L₁ to Lₙ are determined in association with the heights of the sensor H₁ to Hₙ.

For example, the conductivity L₁ corresponds to the height of the sensor H₁, the conductivity L₂ to the height L₂, the conductivity L₃ to the height H₃ and so on. The sensor is preferably guided on a lift, wherein a height of 0 mm of the lift means that the sensor is not immersed in solution and is outside the extraction mixture. The lowest lift position is the position that allows maximum immersion of the sensor. Preferably, the lowest lift position or total lift height is 118 mm.

Preferably, the extraction device has a suction hose that is guided at a defined distance from the sensor, and preferably 11 mm below the sensor.

This distance between the sensor and extraction tube allows stirring without restriction by the sensor or extraction tube in the extraction vessel.

The conductivity in the upper phase can be determined on a lift position, for example, which can be calculated as follows:

[Lift height total (e.g. 118 mm)+distance sensor to hose (e.g. 11 mm)−volume reaction mixture*volume factor 0.8−dilution*volume factor 0.8−volume brine*volume factor 0.8−5 mm]=H_{OP}

(height upper phase; German: OP=obere Phase),
wherein the dilution factor and the brine factor are optional.

The velocities v₁ to vₙ can represent discrete velocities. A velocity greater than vₙ, i.e. preferably the preceding velocity and particularly preferably all preceding velocities, can be 100 to 250 mL/min, for example. vₙ can then be 1 to 20 mL/min, for example.

Step iii) of the method may include:
a) determining the conductivity in the upper phase Lₒ,
b) determining the conductivity in the lower phase Lᵤ,
c) determining a fictitious phase boundary value L_{f} according to [(Lᵤ−Lₒ)/phase boundary factor]+Lₒ, if the hydrophilic phase is the lower phase or determination of the fictitious phase boundary value L_{f} according to [(Lₒ−Lᵤ)/phase boundary factor]+Lᵤ, if the hydrophilic phase is the upper phase.

The phase limit factor is an empirical value that reflects the sensitivity of the system. The higher the phase limit factor is selected, the lower the risk of the lower phase being suctioned off. Lower phase limit factors lead to suctioned off closer to the phase boundary, as the sensor is immersed deeper into the solution. Preferably, the value is 2 or 4.

The theoretical phase boundary value can be defined as the phase boundary. The upper phase is preferably extracted if the actual value of the conductivity difference ΔLᵢₛₜ between the hydrophilic phase and the hydrophobic phase is greater than a target value of the conductivity difference ΔLₛₒₗₗ at the phase boundary. If the actual value is greater, a particularly good phase separation can be assumed.

The target value of the conductivity difference ΔLₛₒₗₗ is preferably in the range between 0.01 mS/cm and 0.1 mS/cm, preferably around 0.05 mS/cm, and can be set using software.

For example, the conductivity sensor in the upper phase can be lowered to a first distance from the phase boundary and the conductivity in the upper phase can be determined. The conductivity sensor can then be lowered all the way down into the lower phase and determine the conductivity of the lower phase and/or the sensor can be lowered to a second distance from the phase boundary in the lower phase and determine the conductivity there.

Depending on the fill level in the vessel and the position of the phase boundary, the first distance and/or the second distance can be 2 mm to 10 mm, preferably 4 mm to 7 mm and particularly preferably 5 mm, from the phase boundary.

If the conductivity difference ΔLₛₒₗₗ between the phases falls below the target value in step iii), an extraction aid, preferably brine, can be added.

If the difference in conductivity is too small, this may indicate poor phase separation. Adding an extraction aid and mixing again, as well as allowing a subsequent rest period for phase separation, can improve phase separation. Better phase separation is usually achieved by salting out, for example with brine. Brine refers to salt solutions with at least 14 g of dissolved salts per 1 kg of water. Examples of typical salts for salting out are Sodium chloride (NaCl), ammonium sulphate (NH₄)₂SO₄ or potassium sulphate (K₂SO₄).

After salting out, the conductivity difference ΔLᵢₛₜ can be determined again in accordance with step iii) and, if the value is sufficiently high, extraction can be carried out as described above. Salting out can be repeated once or several times to optimise the result.

If the actual value of the conductivity difference ΔLᵢₛₜ is still below the target value of the conductivity difference ΔLₛₒₗₗ, this may indicate an emulsion or a large intermediate phase. In this case, the sensor can be moved to a calculated average level of a fictitious lower phase. For extractions with a lighter extraction solvent, this is calculated in the first extraction step, for example (a) using the sample volume used and an extraction vessel-specific volume factor, or in the subsequent extraction steps (b) using the last extraction height:

Hₘₑₐₙ=([Lowest lift position]+[Distance between lift capacity sensor and suction tube]−[Sample volume]*[Volume factor])/2 (a)

Hₘₑₐₙ=([Lowest lift position]+[Distance lift capability sensor to suction hose]−[Lift position last suction]/2 (b):

When extracting with a heavier extraction solvent, the average height can be calculated using its extraction solvent volume (c), for example:

Hₘₑₐₙ=([Lowest lift position]+[Distance lift capacity sensor to suction hose]−[Extraction solution volume]*[Volume factor])/2 (c):

Using a dosing module, the possible emulsion or large intermediate phase can be slowly suctioned off and ejected again. Suitable dosing modules are e.g. OMNIS Dosing Module from Metrohm AG, Switzerland, if the organic phase is lighter than the inorganic phase; or 800 Dosino from Metrohm AG, Switzerland, if the organic phase is heavier than the inorganic phase. The speed can be set using software.

Without being bound by any theory, it is possible that the aspiration and discharged process causes friction in the tubes and the burette and can serve to destroy foams or emulsions that have formed and to form clear phase boundaries. The dosing module can be used to ensure that the lighter phase is discharged first and then the heavier phase, thus preventing re-mixing during discharged in the extraction vessel. In the case of the Dosino, the sensor can be raised to a theoretical phase boundary during discharged and the heavier phase can be discharged first, followed by the lighter phase. Step iii) can then be repeated.

Preferably, the at least one speed v₁ is set as a function of ΔLᵢₛₜ. The higher ΔLᵢₛₜ is, the higher the speed for suction can be.

The speed vₙ is preferably set as a function of ΔLᵢₛₜ. The lower ΔLᵢₛₜ is, the lower the speed for suction can be.

Preferably, the upper phase is extracted at at least two different distances a₁ to aₙ from the phase boundary, particularly preferably at two distances a₁ and a₂, wherein the first distance a₁ is greater than the second distance a₂ and wherein the first velocity v₁ is higher than the second velocity v₂.

Preferably, the first suction speed v₁ is between 50 ml/min and 150 ml/min, even more preferably between 70 ml/min and 130 ml/min, particularly preferably between 90 ml/min and 110 ml/min, especially preferably at 100 ml/min.

Preferably, the second suction speed v₂ is between 10 ml/min and 30 ml/min, even more preferably between 14 ml/min and 26 ml/min, particularly preferably between 18 ml/min and 22 ml/min, most preferably at 20 ml/min.

An intermediate phase may be detected, in particular after step iii). The detection of the intermediate phase may comprise the following steps:
a) determining the height H_{f}, which corresponds to the conductivity L_{f},
b) determining the conductivity L_{f-x} with the conductivity sensor at position H_{f-x},
c) determining the conductivity L_{f+y} with the conductivity sensor at position H_{f+y}.
d) determining the liquid level H_{Liquid},
e) determining the conductivity L_{liquid} at the position H_{liquid},
f) determining the conductivity L_{lower} at the lowest level.

The presence of the intermediate phase can be indicated by L_{f+y}−L_{liquid}≥ΔLₛₒₗₗ and/or L_{lower}−L_{f-x}≥ΔLₛₒₗₗ.

The liquid height corresponds to the height of the liquid/air phase boundary. H_{liquid} is determined from the extraction mixture comprising the extraction material, extraction agent, any extraction aids and any diluents.

The lowest level corresponds to the lowest lift position and the maximum immersion position of the sensor in the extraction mixture. Preferably, the lowest level is 118 mm, analogue to the lowest lift position.

The height H_{f} can be the height of the phase boundary, for example. In this case, the height H_{f-x} can indicate a height below the phase boundary, for example a height 5 mm below the phase boundary. In this case, H_{f-x}=H_{f-5 mm}. The height H_{f+y} can indicate a height above the phase boundary, for example a height 2 mm above the phase boundary. In this case, H_{f+y}=H_{f+2 mm}. Of course, the heights can be adjusted depending on the volumes used and can be adapted to the respective extraction. Usually, the conductivity is selected 2 mm above the phase boundary and 3 mm below the uppermost level. The top level can be determined as follows:

Liquid height=[Lowest lift position]+[Distance conductivity sensor to suction tube]−[Sample volume]*[Volume factor]−[Extraction solvent volume]*[Volume factor]−[Dilution solvent volume]*[Volume factor]−[Auxiliary solvent volume]*[Volume factor].

If the difference is greater than a predefined value, for example greater than a predefined value between 0.005 mS and 0.05 mS, an intermediate phase is assumed. For example, the difference can be greater than 0.05 mS. If there is no intermediate phase in the upper phase (L_{f+y}−L_{liquid}<ΔLₛₒₗₗ), the lower phase is checked in the same way. The conductivity is measured 2 mm below the phase boundary and at the lowest lift position and evaluated in the same way. If the measuring distances to the phase boundary are increased, small intermediate phases can be accepted or permitted.

If the intermediate phase is present, suction and discharging of the intermediate phase can take place. The suctioned up and discharged intermediate phase is eliminated by the resulting friction. Intermediate phases can occur, for example, during the extraction of saponins, surfactants or proteins.

Before determining the phase boundary, it can be determined whether the sensor is clean or the purity of the sensor can be determined and, if necessary, a cleaning step of the sensor can be carried out. The automated cleaning step prevents errors during extraction due to incorrectly assumed conductivity values. The conductivity in the air is measured when the lift is extended (L_{Air}). If this value is greater than 0.005 mS, this indicates contamination. In this case, the system can move the sensor to a cleaning position, clean it with an appropriate solvent, dry it by air flow and rinse the suction hoses with a suitable priming solvent, e.g. brine or water, to prevent cleaning solvents from being carried into the system. The phase boundary can then be determined.

Preferably, a pH value of the hydrophilic phase can be adjusted. For example, by adjusting the pH value, it is possible to influence which component to be extracted is extracted. This also makes it possible, after a first extraction, to change the pH of the aqueous solution in such a way that, for example, a second component can be extracted from the same aqueous solution in a second extraction step according to the method of the invention. It is also possible that undesirable substances which have been co-extracted can be washed out of the extract again by changing the pH value.

In this way, several extractions can be carried out with the same solution. This in turn enables particularly efficient extractions without interruption.

If the inorganic phase, preferably the lower phase, is not to be further extracted with organic solvent but is to be discarded, as is the case in a washing process, for example, a residual portion of organic solvent, which is caused by the meniscus effect of the surface tension, can first be mixed or diluted twice with a small add-on volume of e.g. 5 mL, suctioned off and collected. The lower phase can then be discarded.

A second aspect of the invention relates to an extraction device for carrying out a method as previously described.

Such a device is characterised by its low susceptibility to errors and enables efficient and time-saving extraction compared to manual methods.

Preferably, the extraction device has a lift for guiding the conductivity sensor and an extraction hose.

The extraction device can include a pH meter. This allows the pH value within the extraction material to be determined.

A third aspect of the invention relates to a computer program. The computer program comprises instructions that cause the extraction device as previously described to perform the method steps as previously described.

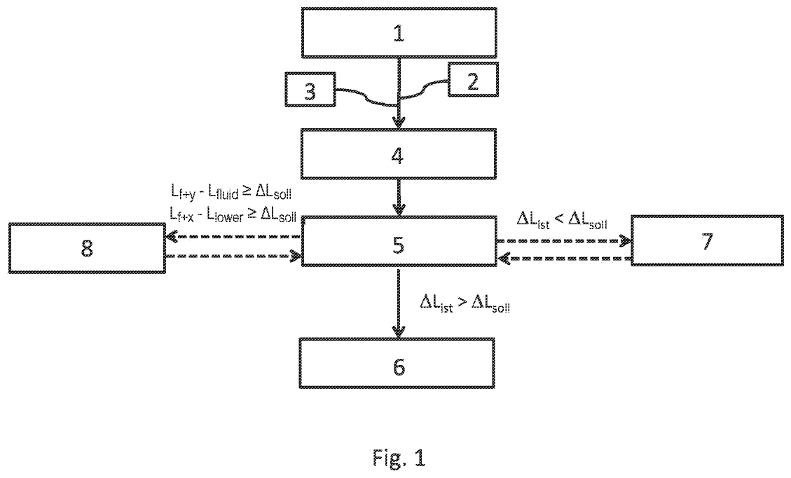

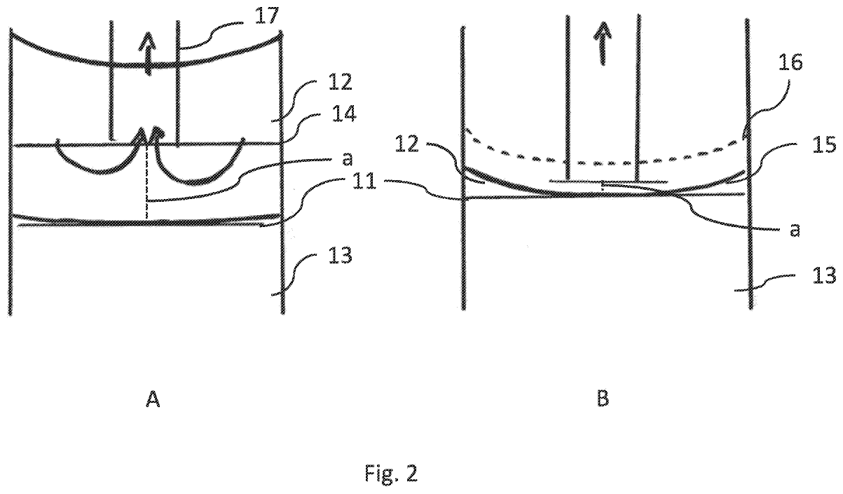

The invention is explained in more detail below using FIGS. 1 and 2 and Examples 1 to 3 as examples. The explanations are not intended to be restrictive. It shows:

FIG. 1 a flowchart of the individual steps of the method according to the invention.

FIG. 2 a schematic representation of the suction of the upper phase at different speeds.

FIG. 1 illustrates the method using individual process steps as examples. In the first step 1, an extraction device is provided. A hydrophilic, inorganic phase 2 is fed to this extraction device, followed by an organic solvent 3 as the hydrophobic, organic phase. The two phases are mixed with stirring 4 and, after a rest period for phase separation, a conductivity difference ΔLᵢₛₜ between the hydrophilic phase and the hydrophobic phase is determined in step 5 using a conductivity sensor. To do this, the conductivity sensor is lowered to 5 mm above a determined phase boundary and the conductivity in the upper phase is measured. The conductivity sensor is then lowered completely into the lower phase and the conductivity of the lower phase is measured. If the conductivity difference ΔLᵢₛₜ is greater than the target value ΔLₛₒₗₗ of 0.05 mS/cm, the upper phase is first suctioned off at 100 mL/min in step 6 and then at 20 ml/min (FIG. 2).

If ΔLᵢₛₜ is below ΔLₛₒₗₗ of 0.05 mS/cm, the phase separation is not sufficient and brine is added to the mixture in accordance with step 7. The conductivity difference is then determined again in accordance with step 5 and, if ΔLᵢₛₜ>ΔLₛₒₗₗ, suction is carried out in accordance with step 6 at two different speeds.

Alternatively, it is possible to index an intermediate phase in step 5. For this purpose, a conductivity value 2 mm above the phase boundary is determined L_{f+2 mm} (L_{f+y}) and a conductivity value 3 mm below the uppermost level is determined L_{liquid}. If the conductivity difference is <0.05 mS/cm, this process is carried out with the lower phase. A conductivity value 2 mm below the phase boundary is determined L_{f-2 mm} (L_{f-y}) and a conductivity value at the lowest point is determined L_{lowest}. If the conductivity difference is >0.05 mS/cm (ΔLₛₒₗₗ) in one of the two cases, the intermediate phase is indexed and this is suctioned off in step 8 and ejected again to enable phase separation. The conductivity is then determined again according to step 5 and if ΔLᵢₛₜ>ΔLₛₒₗₗ the upper phase is suctioned off according to step 6.

FIG. 2 schematically shows the extraction step 6 from FIG. 1 with two different speeds. In FIG. 2A, the organic phase 12 is suctioned off at a distance a from the phase boundary 11 at a speed of 100 mL/min via a suction hose 17. Subsequently, a protruding residue 16 of the organic phase 12 is suctioned off at a speed of 20 mL/min, as shown schematically in FIG. 2B. What remains is the inorganic phase 13 with the meniscus 15 of the upper phase 15, which can be mixed or diluted by adding an add-on volume of approx. 5 mL twice, which would roughly correspond to the height of the phase 16, and suctioned off.

### EXAMPLE 1

A reaction mixture of acetic acid benzyl ester, benzyl alcohol, acetic acid, sulphuric acid and by-products was extracted as follows:

The reaction volume of 39 mL was diluted with 15 mL H₂O in a vessel of the extraction device, a robotic system, 2 mL brine was added as extraction agent and 25 mL ethyl acetate was added. The extraction mixture was mixed for 10 seconds with stirring strength 15. A phase separation was carried out during 60 sec waiting time.

Firstly, the conductivity was measured at the lift position 0 mm (Lₐᵢᵣ) and resulted in a conductivity value of 0.0000 mS, indicating a clean sensor.

The conductivity was then measured at the lift height or lift position of 79 mm. The lift position was calculated using the following formula

[Lift height total (118 mm)+distance sensor to tube (11 mm)−volume reaction mixture 39 ml*volume factor 0.8−dilution 15 ml*volume factor 0.8−brine 2 ml*volume factor 0.8−5 mm]: 0.009460586 mS. (1)

The conductivity was then measured at a lift height of 118 mm: 2.036342 mS.

The conductivity phase limit value L_{f} was calculated: 0.516181 mS.

The sensor was then raised to a lift height of 79 mm and slowly lowered until the conductivity of 0.516181 was exceeded. The final lift height was determined to be 85 mm.

The lift was lowered to 67 mm (phase boundary 85 mm-distance sensor to tube 11 mm-2 mm) and the upper phase was suctioned off at 100 mL/min and collected in a separate vessel.

The lift was then lowered to 72 mm (phase limit 85 mm-distance sensor to tube 11 mm-7 mm) and the phase was suctioned off at 20 mL/min and collected in a separate vessel.

### EXAMPLE 2

The first extraction was carried out according to example 1.

Another 25 mL of ethyl acetate was then added to the residue. The extraction mixture was mixed for 10 seconds with a stirring strength of 15. The phase separation takes place during a waiting time of 60 seconds.

The conductivity was measured at the 0 mm lift position and gave a value of 0.07 mS. The sensor was contaminated. The sensor was moved to the wash position and rinsed with 10 mL acetone and then dried for 60 seconds with the stirrer running. The tubes were rinsed with brine.

The conductivity was then determined at a lift height of 80 mm (85 mm from the first extension−5 mm) according to formula (1): 0.0292257 mS. The conductivity was then determined at a lift height of 118 mm: 1.776728 mS. The conductivity at the phase boundary value was calculated as 0.466101 mS.

The lift was lowered to 69 mm (phase boundary 87 mm-distance sensor to tube 11 mm−7 mm) and the upper phase was suctioned off at 100 mL/min and collected in a separate vessel.

The lift was then lowered to 74 mm (phase boundary 87 mm-distance sensor to tube 11 mm−2 mm) and the remainder of the upper phase was suctioned off at 20 mL/min and collected in a separate vessel.

Subsequently, 2×5 mL of ethyl acetate were added as an add-on volume, suctioned off and collected in a separate vessel.

The aqueous phase was then suctioned off and discarded.

### EXAMPLE 3

In example 3, the steps according to examples 1 and 2 were carried out and then washed.

The ethyl acetate phases from examples 1 and 2 were placed in an extraction beaker and mixed with 15 mL Na₂CO₃. The extraction mixture was then mixed for 10 seconds at stirring strength 15 and the phase separation was allowed to take place for 60 seconds.

Firstly, the conductivity was measured at the lift position 0 mm (Lₐᵢᵣ) (0.0007 mS), which did not result in a contaminated sensor.

The conductivity was then measured at a lift height of 112 mm (0.001934008 mS), the conductivity was measured at a lift height of 118 mm (0.7977153 mS) and the phase limit value was determined (0.200879 mS).

The sensor was raised to a lift height of 112 mm and slowly lowered until the conductivity of 0.200879 was exceeded. This resulted in a final lift height of 114 mm. The lift was lowered to 96 mm (phase limit 114 mm−distance sensor to tube 11 mm−7 mm) and the phase was suctioned off at 100 mL/min and collected. The lift was then moved to 101 mm (phase limit 109 mm−distance sensor to tube 11 mm−2 mm) and the phase was suctioned off and collected at 20 mL/min.

Subsequently, 2×5 mL ethyl acetate are added as an add-on volume, suctioned off and collected. The lift is lowered to 118 mm and the pH value is determined. The pH value was 7.8. The aqueous phase was suctioned off and discarded.

The collected extracts were placed in the extraction beaker and mixed with 15 mL of water. The extraction mixture was then mixed for 10 seconds at stirring strength 15 and the phase separation was waited for 60 seconds. First, the conductivity was measured at the 0 mm lift position (0.0007 mS), which did not result in a contaminated sensor. The conductivity was then measured at the 112 mm lift height:

[Lift height total 118 mm+distance sensor to tube 11 mm−volume H₂O 15 ml*volume factor 0.8−5 mm]: 0.001134568 mS

The conductivity was measured at a lift height of 118 mm (0.045342 mS). The difference in conductivity was too small, so 2 mL of brine was added to the extraction mixture.

The extraction mixture was then mixed again for 10 seconds at stirring strength 15 and the phase separation waited for 60 seconds. Firstly, the conductivity was measured again at the 0 mm lift position (0.0009 mS), which did not result in a contaminated sensor. The conductivity was then measured at the 110 mm lift height:

[Lift height total 118 mm+distance sensor to hose 11 mm−volume H₂O 15 ml*volume factor 0.8−brine 2 mL*volume factor 0.8−5 mm]: 0.001735 mS

The conductivity was measured at a lift height of 118 mm (1.667378 mS).

The conductivity phase limit was determined to be 0.418146 mS.

The sensor was raised to a lift height of 110 mm and slowly lowered until the conductivity of 0.418146 was exceeded. This resulted in a final lift height of 113 mm. The lift was lowered to 95 mm (phase limit 113 mm−distance sensor to tube 11 mm−7 mm) and the phase was suctioned off at 100 mL/min and collected. The lift was then raised to 100 mm (phase limit 109 mm−distance sensor to tube 11 mm−2 mm) and the phase was suctioned off and collected at 20 mL/min.

Subsequently, 2×5 mL of ethyl acetate were added as an add-on volume, suctioned off and collected. The aqueous phase was discarded.

1-16. (canceled)

17. A method for automated liquid-liquid extraction comprising the steps of:
i) providing an extraction device,
ii) providing a vessel with a hydrophilic phase and a hydrophobic phase, wherein at least one component to be extracted is contained in one of the two phases,
iii) determining a conductivity difference ΔLᵢₛₜ between the hydrophilic phase and the hydrophobic phase by means of a conductivity sensor;
wherein the upper phase is extracted at at least two different speeds v₁ to vₙ,
wherein the last speed vₙ is slower than a previous speed vₙ₋₁.

18. The method according to claim 17, wherein the conductivity sensor is guided through the phases in such a way that determined conductivities L₁ to Lₙ are determined associated with heights of the sensor H₁ to Hₙ.

19. The method according to claim 17, wherein the velocities v₁ to vₙ are discrete velocities.

20. The method according to claim 17, wherein step iii) comprises the steps of:
a) determining the conductivity in the upper phase Lₒ,
b) determining the conductivity in the lower phase Lᵤ,
c) determining a fictitious phase boundary value L_{f} according to [(Lᵤ−Lₒ)/phase boundary factor]+Lₒ, if the hydrophilic phase is the lower phase or determining the fictitious phase boundary value L_{f} according to [(Lₒ−Lᵤ)/phase boundary factor]+Lᵤ, if the hydrophilic phase is the upper phase.

21. The method according to claim 17, wherein, if in step iii) the conductivity difference ΔLₛₒₗₗ between the phases falls below a target value, an extraction aid is added.

22. The method according to claim 17, wherein v₁ is set as a function of ΔLᵢₛₜ.

23. The method according to claim 17, wherein vₙ is set as a function of ΔLᵢₛₜ.

24. The method according to claim 17, wherein the suction of the upper phase takes place at at least two different distances a₁ to aₙ from the phase boundary.

25. The method according to claim 24, wherein at least one of the first suction speed v₁ is between 50 ml/min and 150 ml/min; and the second suction speed v₂ is between 10 ml/min and 30 ml/min.

26. The method according to claim 17, wherein, in particular after step iii), an intermediate phase is detected, comprising the steps of:
a) determining the height H_{f}, which corresponds to the conductivity L_{f},
b) determining the conductivity L_{f-x} with the conductivity sensor at the position H_{f-x},
c) determining the conductivity L_{f+y} with the conductivity sensor at position H_{f+y},
d) determining the liquid level H_{liquid},
e) determining the conductivity L_{liquid} at position H_{liquid},
f) determining the conductivity L_{lowest} the lowest level,
wherein the presence of the intermediate phase is indicated by at least one of L_{f+y}−L_{liquid}≥ΔLₛₒₗₗ and L_{lowest}−L_{f-x}≥ΔLₛₒₗₗ.

27. The method according to claim 26, wherein suction and discharging of the intermediate phase takes place in the presence of the intermediate phase.

28. The method according to claim 17, wherein the purity of the sensor is determined prior to a determination of the phase boundary and, if necessary, a cleaning step of the sensor is carried out.

29. The method according to claim 17, wherein a pH value of the hydrophilic phase is adjustable.

30. An extraction apparatus for carrying out a method according to claim 17.

31. The extraction apparatus according to claim 30 comprising a pH meter.

32. A computer program comprising instructions that cause the extraction device according to claim 30 to perform the method comprising the steps of
providing the extraction device,
providing a vessel with a hydrophilic phase and a hydrophobic phase, wherein at least one component to be extracted is contained in one of the hydrophilic and the hydrophobic phases,
determining a conductivity difference ΔLᵢₛₜ between the hydrophilic phase and the hydrophobic phase by means of a conductivity sensor, wherein the upper phase is extracted at at least two different speeds v₁ to vₙ, wherein the last speed vₙ is slower than a previous speed vₙ₋₁.
